(19) United States
(12) Patent Application Publication
(10) Pub. No.: US 2025/0141644 A1
(43) Pub. Date: May 1, 2025

(54) ADAPTIVE COMMUNICATION OF SYSTEM INFORMATION

(71) Applicant: Lenovo (Singapore) Pte. Limited, Singapore (SG)

(72) Inventors: Hyejung Jung, Northbrook, IL (US); Joachim Löhr, Wiesbaden (DE); Vijay Nangia, Woodridge, IL (US)

(73) Assignee: Lenovo (Singapore) Pte. Limited, Singapore (SG)

(21) Appl. No.: 18/836,698

(22) PCT Filed: Feb. 6, 2023
(86) PCT No.: PCT/IB2023/051057

§ 371 Date: Aug. 7, 2024

Related U.S. Application Data
(60) Provisional application No. 63/307,968, filed on Feb. 8, 2022.

(51) Int. Cl. H04L 5/00; H04W 72/1273

(52) U.S. Cl. CPC H04L 5/0094; H04L 5/0048; H04W 72/1273

(57) ABSTRACT

Various aspects of the present disclosure relate to a UE that receives an indication of one or more system information transmission repetition periodicity values corresponding to a respective subset of synchronization signal blocks (SSBs) within a burst of SSBs. The UE selects at least one SSB from the burst of SSBs, and receives a system information message via one or more physical downlink control channel (PDCCH) monitoring occasions in a search space set for the system information message. The one or more PDCCH monitoring occasions, for instance, are determined based on a system information transmission repetition periodicity value of the one or more system information transmission repetition periodicity values, and the system information transmission repetition periodicity value corresponds to the selected SSB. The UE can implement wireless communication using system information determined from the received system information message.

### RELATED APPLICATION

This application claims priority to U.S. Provisional Patent Application Ser. No. 63/307,968, filed 8 Feb. 2022 titled “ADAPTIVE COMMUNICATION OF SYSTEM INFORMATION,” the disclosure of which is hereby incorporated by reference herein in its entirety.

### TECHNICAL FIELD

The present disclosure relates to wireless communications, and more specifically to communication of system information in wireless systems.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

Different wireless technologies utilize different wavelength spectra for wireless communication. Further, wireless communication at different wavelengths can be associated with different transmit and receive power profiles. For instance, different signaling utilized for wireless transmission and reception at different wavelengths can affect power usage by network communication devices (e.g., base stations) and UEs that communicate with the network communication devices.

### SUMMARY

The present disclosure relates to methods, apparatuses, and systems that support adaptive communication of system information. For instance, the described techniques enable a network node to flexibly adapt its beam sweeping of signals such as system information block 1 (SIB1) and paging messages based on estimated and/or predicted UE locations. Further, a UE is enabled to adapt its SIB1 and paging reception and radio resource management (RRM) and/or radio link monitoring (RLM) measurements accordingly. By utilizing the described techniques, a network device such as a base station can reduce transmission periodicity of some signals (e.g., SIB1, paging messages) and thus reduce power usage and resource usage (e.g., transmit/receive resources) at the network device. Further, by notifying a UE of adapting signal transmission by a network device, the UE can reduce power usage and resource usage (e.g., transmit/receive resources) and adapt its RRM and RLM based on the adapted signal transmission.

Some implementations of the method and apparatuses described herein may include wireless communication at a device (e.g., at a UE), which includes receiving (e.g., from a base station (e.g., a gNB)) an indication of one or more system information transmission repetition periodicity values corresponding to a respective subset of synchronization signal blocks (SSBs) within a burst of SSBs; selecting at least one SSB from the burst of SSBs; receiving a system information message via one or more physical downlink control channel (PDCCH) monitoring occasions in a search space set for the system information message, the one or more PDCCH monitoring occasions determined based on a system information transmission repetition periodicity value of the one or more system information transmission repetition periodicity values, and the system information transmission repetition periodicity value corresponding to the selected at least one SSB; and implementing wireless communication using system information determined from the received system information message

In some implementations of the method and apparatuses described herein, an indication is received of a plurality of SSB transmission periodicity values, where each subset of SSBs within the burst of SSBs is configured with a SSB transmission periodicity value of the plurality of SSB transmission periodicity values, and where each of the one or more system information transmission repetition periodicity values corresponds to a respective SSB transmission periodicity value of the plurality of SSB transmission periodicity values; receiving the indication of the one or more system information transmission repetition periodicity values as an implicit indication based on the plurality of SSB transmission periodicity values; receiving an indication of time domain positions of available SSBs within the burst of SSBs, where the indication of time domain positions indicates that a SSB with a first index is not available during a corresponding indication validity interval; where the SSB with the first index is included in a resource set configured for radio link quality assessment, and not using the SSB with the first index for radio link quality assessment during the corresponding indication validity interval; where the SSB with the first index is quasi-co-located with a CSI-RS resource included in a resource set configured for radio link quality assessment, and not using the CSI-RS resource for radio link quality assessment during the corresponding indication validity interval.

In some implementations of the method and apparatuses described herein, one or more PDCCHs are monitored in a PDCCH monitoring occasion of paging downlink control information (DCI) during the corresponding indication validity interval, and where the PDCCH monitoring occasion of the paging DCI is not quasi-co-located with the SSB with the first index; monitoring one or more PDCCHs in a PDCCH monitoring occasion of a common search space set for system information delivery during the corresponding indication validity interval, and where the PDCCH monitoring occasion of the common search space set for system information delivery is not quasi-co-located with the SSB with the first index; where the indication of time domain positions of available SSBs within the burst of SSBs is received via at least one of a medium access control control element (MAC-CE) or DCI; where the system information message includes at least a part of a minimum system information for a cell of a wireless network.

Some implementations of the method and apparatuses described herein may include wireless communication at a device (e.g., at a base station), which includes transmitting (e.g., to a UE) an indication of one or more system information transmission repetition periodicity values corresponding to a respective subset of SSBs within a burst of SSBs; and performing a plurality of transmissions of a system information message, where each transmission of the system information message is quasi-co-located with a SSB within the burst of SSBs and is repeated with a system information transmission repetition periodicity value corresponding to the SSB.

In some implementations of the method and apparatuses described herein, a spatial distribution of user equipment is estimated within a wireless service area and generating the one or more system information transmission repetition periodicity values based on the spatial distribution of the user equipment; where generating the one or more system information transmission repetition periodicity values based on the spatial distribution of the user equipment includes to decrease a current system information transmission repetition periodicity value corresponding to a SSB within the burst of SSBs; transmitting an indication of a plurality of SSB transmission periodicity values, where each subset of SSBs within the burst of SSBs is configured with a SSB transmission periodicity value of the plurality of SSB transmission periodicity values, and where each of the one or more system information transmission repetition periodicity values corresponds to a respective SSB transmission periodicity value of the plurality of SSB transmission periodicity values; and transmitting the burst of SSBs based on the plurality of SSB transmission periodicity values;

In some implementations of the method and apparatuses described herein, an indication is generated of time domain positions of available SSBs within the burst of SSBs, where the indication of time domain positions indicates that a SSB with a first index is not available during a corresponding indication validity interval; and transmitting the indication of time domain positions; generating the indication of time domain positions as one or more of a MAC-CE or DCI; performing a set of transmissions of a system information message and a set of transmissions of a paging message corresponding to the available SSBs within the burst of SSBs; generating a MIB that identifies the one or more system information transmission repetition periodicity values; and transmitting the MIB.

### BRIEF DESCRIPTION OF THE DRAWINGS

Various aspects of the present disclosure for adaptive communication of system information are described with reference to the following Figures. The same numbers may be used throughout to reference like features and components shown in the Figures.

FIG. 1 illustrates an example of a wireless communications system that supports adaptive communication of system information in accordance with aspects of the present disclosure.

FIG. 2 illustrates an example block diagram of components of a device (e.g., a UE) that supports adaptive communication of system information in accordance with aspects of the present disclosure.

FIG. 3 illustrates an example block diagram of components of a device (e.g., a base station) that supports adaptive communication of system information in accordance with aspects of the present disclosure.

FIGS. 4, 5, 6, 7, 8 illustrate flowcharts of methods that support adaptive communication of system information in accordance with aspects of the present disclosure.

### DETAILED DESCRIPTION

Implementations of adaptive communication of system information are described, such as related to enabling a network node to flexibly adapt its beam sweeping of signals such as SIB1 and paging messages based on estimated and/or predicted UE locations. Further, a UE is enabled to adapt its SIB1 and paging reception RRM and/or RLM measurements accordingly. By utilizing the described techniques, a network device such as a base station can reduce transmission periodicity of some signals (e.g., SIB1, paging messages) and thus reduce power usage and resource usage (e.g., transmit/receive resources) at the network device. Further, by notifying a UE of adapting signal transmission by a network device, the UE can reduce power usage and resource usage (e.g., transmit/receive resources) and adapt its RRM and RLM based on the adapted signal transmission.

Wireless technologies are constantly evolving to provide increased quality and capacity in wireless networks. For instance, in 5G New Radio (NR), use of millimeter wave spectrum along with network densification can significantly boost area capacity. Further, 5G NR features such as a configurable synchronization signal and physical broadcast channel periodicity ranging from 5 ms to 160 milliseconds (ms) and on-demand system information delivery can make 5G NR more energy efficient as compared with previous RATs in terms of required energy per bit. However, densely deployed network nodes and relatively high energy consumption per node from massive multiple-input and multiple-output (MIMO) implementations and/or high frequency band operations can lead to overall increased energy consumption by 5G NR infrastructure.

Accordingly, adaptive communication of system information described herein addresses some of these concerns and enables energy and resource conservation across a wireless network. For instance, adaptive SIB1 transmission repetition periodicity is described where a UE receives information from a network device (e.g., a base station) of at least one SIB1 transmission repetition periodicity, where each of the at least one SIB1 transmission repetition periodicity corresponds to a subset of SSBs within a SSB burst. The UE then selects at least one SSB for receiving SIB1, and determines one or more frames and/or slots. Further, the UE monitors PDCCH in a Type0-PDCCH common search space (CSS) set (e.g., a search space set for DCI scheduling a SIB1 PDSCH), based on a SIB1 transmission repetition periodicity of the at least one SIB1 transmission repetition periodicity corresponding to the selected at least one SSB. The UE can receive a system information message based on the monitoring, and utilize information from the system information message to implement wireless communication

Implementations also support adaptive SIB1 and paging reception and adaptive RRM and RLM measurements. For instance, a UE receives a dynamic indication of time domain positions of transmitted SSBs within an SSB burst indicating that an SSB with index i is not available (e.g., is not transmitted by a network entity such as a base station) for an associated indication validity duration. The dynamic indication, example, is received from a base station signaled in medium access control control element (MAC-CE), or DCI such as paging DCI or paging early indication DCI. In at least one implementation the UE is configured to determine that a PDCCH that schedules a PDSCH carrying a SIB1 and the corresponding SIB1 PDSCH, which are quasi-co-located with the SSB with index i, are not transmitted by the base station and does not monitor PDCCH candidates on PDCCH monitoring occasions of a Type0-PDCCH CSS set corresponding to the SSB with index i for the associated indication validity duration.

The UE can also be configured to determine that paging DCI and a corresponding paging PDSCH, which are quasi-co-located with the SSB with index i, are not transmitted by the network entity and does not monitor PDCCH candidates on PDCCH monitoring occasions of a Type2-PDCCH CSS set (e.g., a search space set for paging DCI) corresponding to the SSB with index i for the associated indication validity duration. Further, the UE may not use the unavailable SSB with index i and a CSI-RS resource quasi-co-located with the unavailable SSB with index i, such as for RLM and link quality evaluation for the associated indication validity duration.

Thus, the present disclosure provides increased energy conservation and wireless performance compared with some wireless systems. For instance, by utilizing the described techniques, a network device such as a base station can reduce transmission periodicity of some signals (e.g., SIB1, paging messages) and thus reduce power usage and resource usage (e.g., transmit/receive resources) at the network device. Further, by notifying a UE of adapting signal transmission by a network device, the UE can reduce power usage and resource usage (e.g., transmit/receive resources) and adapt its RRM and RLM based on the adapted signal transmission.

Aspects of the present disclosure are described in the context of a wireless communications system. Aspects of the present disclosure are further illustrated and described with reference to device diagrams and flowcharts that relate to adaptive communication of system information.

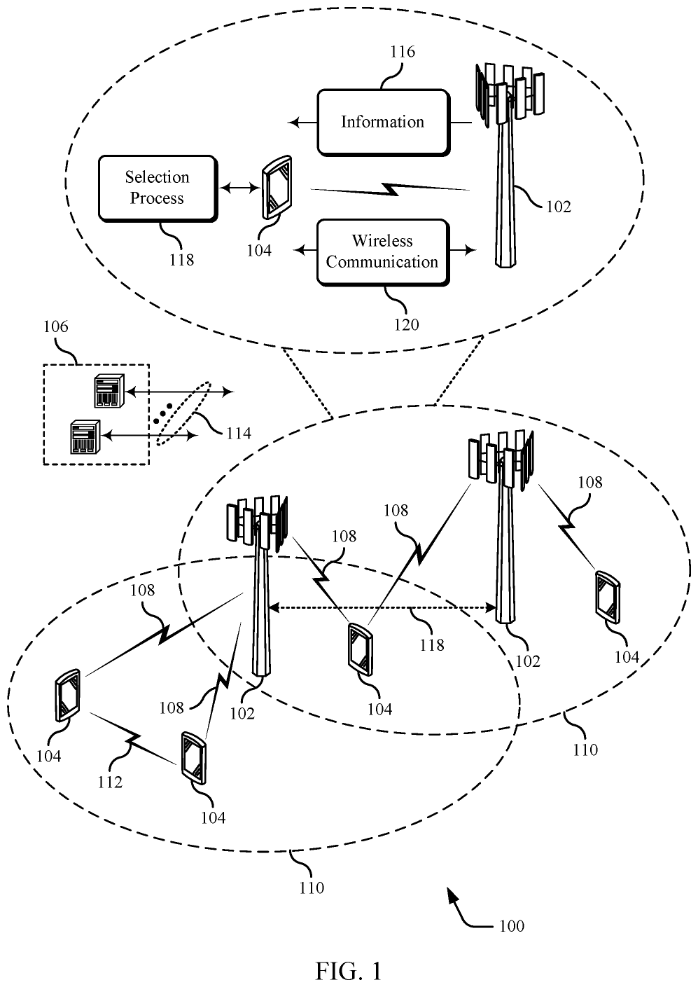

FIG. 1 illustrates an example of a wireless communications system 100 that supports adaptive communication of system information in accordance with aspects of the present disclosure. The wireless communications system 100 may include one or more base stations 102, one or more UEs 104, a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 and base stations 102 are operable to implement various aspects of adaptive communication of system information, as described herein. For instance, a base station 102 can communicate information 116 that includes various information such as an indication of one or more system information transmission repetition periodicity values corresponding to a respective subset of SSBs within a burst of SSBs from the base station 102. The UE 104 implements a selection process 118 where the UE selects at least one SSB from the burst of SSBs from the base station 102, and receives a system information message from the base station (e.g., as part of the information 116) via one or more PDCCH monitoring occasions in a search space set for the system information message. The one or more PDCCH monitoring occasions, for instance, are determined based on a system information transmission repetition periodicity value for the selected SSB. The UE 104 can then implement wireless communication 120 with the base station 102 using system information determined from the received system information message.

In some wireless systems, guidelines are provided for transmitting and receiving system information, such as between a wireless network (e.g., base stations) and UEs. For instance, in the context of a UE procedure for determining PDCCH assignment, a set of PDCCH candidates for a UE to monitor can be defined in terms of PDCCH search space sets. A search space set can be a CSS set or a UE-specific search space (USS) set. A UE, for instance, monitors PDCCH candidates in one or more of the following search spaces sets:
a Type0-PDCCH CSS set configured by pdcch-ConfigSIB1 in MIB or by searchSpaceSIB1 in PDCCH-ConfigCommon or by searchSpaceZero in PDCCH-ConfigCommon for a DCI format with cyclical redundancy check (CRC) scrambled by a system information-radio network temporary identifier (SI-RNTI) on the primary cell of the master cell group (MCG);
a Type0A-PDCCH CSS set configured by searchSpaceOtherSystemInformation in PDCCH-ConfigCommon for a DCI format with CRC scrambled by a SI-RNTI on the primary cell of the MCG;
a Type1-PDCCH CSS set configured by ra-SearchSpace in PDCCH-ConfigCommon for a DCI format with CRC scrambled by a RA-RNTI, a MsgB-RNTI, or a temporary C-RNTI (TC-RNTI) on the primary cell;
a Type2-PDCCH CSS set configured by pagingSearchSpace in PDCCH-ConfigCommon for a DCI format with CRC scrambled by a P-RNTI on the primary cell of the MCG;
a Type3-PDCCH CSS set configured by SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, or CI-RNTI and, for the primary cell, C-RNTI, MCS-C-RNTI, CS-RNTI(s), or PS-RNTI and
a USS set configured by SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL Semi-Persistent Scheduling V-RNTI.

In at least some implementations, for a downlink bandwidth part (DL BWP), if a UE is not provided searchSpaceSIB1 for Type0-PDCCH CSS set by PDCCH-ConfigCommon, the UE does not monitor PDCCH candidates for a Type0-PDCCH CSS set on the DL BWP. The Type0-PDCCH CSS can be defined by control channel element (CCE) aggregation levels and a number of PDCCH candidates per CCE aggregation level. If the active DL BWP and the initial DL BWP have a same subcarrier spacing (SCS) and same cyclic prefix (CP) length, and the active DL BWP includes all resource blocks (RBs) of the control resource set (CORESET) with index 0, or the active DL BWP is the initial DL BWP, the CORESET configured for Type0-PDCCH CSS set has CORESET index 0 and the Type0-PDCCH CSS set has search space set index 0.

In the context of UE procedure for monitoring Type0-PDCCH CSS sets, if during a cell search a UE determines from MIB that a CORESET for Type0-PDCCH CSS set is present, the UE can determine a number of consecutive resource blocks and a number of consecutive symbols for the CORESET of the Type0-PDCCH CSS set from controlResourceSetZero in pdcch-ConfigSIB1 for operation with or without shared spectrum channel access, and determine PDCCH monitoring occasions from searchSpaceZero in pdcch-ConfigSIB1, such as included in MIB. SFN_{C} and n_{C} can be the SFN and slot index within a frame of the CORESET based on SCS of the CORESET and SFN_{SSB,i} and n_{SSB,i} are the SFN and slot index based on SCS of the CORESET, respectively, where the synchronization signal/physical broadcast channel (SS/PBCH) block with index i overlaps in time with system frame SFN_{SSB,i} and slot n_{SSB,i} The symbols of the CORESET associated with pdcch-ConfigSIB1 in MIB or with searchSpaceSIB1 in PDCCH-ConfigCommon have normal cyclic prefix.

For operation without shared spectrum channel access, a UE can be configured such that an offset is defined with respect to the SCS of the CORESET for Type0-PDCCH CSS set, provided by subCarrierSpacingCommon, from the smallest RB index of the CORESET for Type0-PDCCH CSS set to the smallest RB index of the common RB overlapping with the first RB of the corresponding SS/PBCH block. For operation with shared spectrum channel access, a UE can determine an offset from a smallest RB index of the CORESET for Type0-PDCCH CSS set to a smallest RB index of the common RB overlapping with a first RB of the corresponding SS/PBCH block.

System information (SI) can be divided into an MIB and a number of SIBs and positioning SIBs (posSIBs) where:
The MIB can be transmitted on the BCH with a periodicity of 80 ms and repetitions made within 80 ms and it includes parameters that are used to acquire SIB1 from the cell. The first transmission of the MIB can be scheduled in subframes and repetitions can be scheduled according to the period of SSB;
The SIB1 can be transmitted on the DL-SCH with a periodicity of 160 ms and variable transmission repetition periodicity within 160 ms. The default transmission repetition periodicity of SIB1 can be 20 ms but the actual transmission repetition periodicity can be up to network implementation. For SSB and CORESET multiplexing pattern 1, SIB1 repetition transmission period can be 20 ms. For SSB and CORESET multiplexing pattern 2/3, SIB1 transmission repetition period can be the same as the SSB period. SIB1 includes information regarding the availability and scheduling (e.g., mapping of SIBs to SI message, periodicity, SI-window size) of other SIBs with an indication whether one or more SIBs are to be provided on-demand and, in that case, the configuration used by the UE to perform the SI request. A SIB1, for instance, is a cell-specific SIB;
SIBs other than SIB1 and posSIBs can be carried in SystemInformation (SI) messages, which are transmitted on the DL-SCH. SIBs or posSIBs having the same periodicity can be mapped to the same SI message. SIBs and posSIBs can be mapped to the different SI messages. Each SI message can be transmitted within periodically-occurring time domain windows (referred to as SI-windows with same length for all SI messages). Each SI message is associated with an SI-window and the SI-windows of different SI messages do not overlap. That is, within one SI-window the corresponding SI message is transmitted. An SI message may be transmitted a number of times within the SI-window. In at least one implementation, any SIB or posSIB except SIB1 can be configured to be cell specific or area specific, using an indication in SIB1. The cell specific SIB can be applicable within a cell that provides the SIB while the area specific SIB is applicable within an area referred to as SI area, which consists of one or several cells and is identified by systemInformationAreall);
The mapping of SIBs to SI messages can be configured in schedulingInfoList, while the mapping of posSIBs to SI messages can be configured in posSchedulingInfoList. Each SIB can be contained in a single SI message. In the case of posSIB, a posSIB carrying global navigation satellite systems (GNSS) generic assistance data for different GNSS and/or satellite-based augmentation system (SBAS) can be contained in different SI messages. Each SIB and posSIB, including a posSIB carrying GNSS Generic Assistance Data for one GNSS/SBAS, can be contained at most once in that SI message;
For a UE in RRC_CONNECTED, a network can provide system information through dedicated signalling using the RRCReconfiguration message, e.g., if the UE has an active BWP with no common search space configured to monitor system information, paging, or upon request from the UE.
For primary and secondary cells (PSCell) and secondary cells (SCells), the network can provide the required SI by dedicated signalling, e.g., within an RR (′Reconfiguration message. The UE can acquire MIB of the PSCell to get system frame number (SFN) timing of the secondary cell group (SCG), which may be different from MCG. Upon change of relevant SI for SCell, the network can release and add the concerned SCell. For PSCell, the SI can be changed with Reconfiguration with Sync.

In aspects of adaptive communication of system information, a network entity may flexibly change (e.g., dynamically change via DCI or medium access control (MAC) control element (CE)) a set of transmitted SS/PBCH blocks (e.g., SSBs) out of a set of predefined SSB candidate positions based on a UEs' spatial distribution (e.g., for RRC connected mode UEs) and predicted (e.g., estimated) UE locations. A predicted UE location, for instance, can be based on knowledge of UE spatial distribution in certain geographical locations (e.g., office parks, residential areas, etc.) and/or for different times of a day. For example, a network entity may estimate current UE locations/orientations using 3GPP/non-3GPP positioning technologies, 3GPP CSI reporting (e.g., L1-reference signal receive power (RSRP), L1-signal-to-interference plus noise ratio (SINR) reporting) and/or mobility measurement reporting, various sensors, e.g., radar, camera, etc. Additionally or alternatively a network entity may predict future UE locations based on estimated UE movement directions and speeds. Further, a network entity may determine and/or predict UE locations and/or future locations using artificial intelligence and/or machine learning. In at least one implementation a network entity, based on determined UE location and/or predicted future location, can adjust an SSB transmission pattern, such as within a half frame accordingly.

In alternative or additional implementations, a network entity may transmit a plurality of SSBs within a half frame with different periodicities. For instance, a network entity can determine that there are few (e.g., less than a threshold number) and/or no UEs in an RRC connected state served by a set (e.g., one or more) of SSBs (e.g., DL Tx beams), such as based on UE CSI reporting and/or mobility measurement reporting indicating that there are less than a threshold number of UEs in locations related to the set of SSBs in a cell. Accordingly, in response, the network entity can configure a longer periodicity (e.g., 20 ms or longer) for the set of SSBs. Alternatively or additionally, when a network entity provides one or more TRS occasions which are configured for RRC connected UEs and associated (e.g., quasi-co-located) with a set (e.g., one or more) of SSBs to UEs in an RRC idle and/or RRC inactive state in a cell, the network entity can configure a longer periodicity for the set of SSBs.

According to one or more implementations, a network entity can transmit a dynamic indication (e.g. via DCI or MAC-CE) corresponding to information of time-domain positions of transmitted SSBs in an SSB burst and/or an indication corresponding to information of a plurality of SSB periodicities, where each periodicity is applicable to a subset of SSBs in an SSB burst, e.g., a set of SSBs within a half frame. The dynamic information of time-domain positions of transmitted SSBs in an SSB burst may be different from semi-static configuration information of time-domain positions of transmitted SSBs in an SSB burst provided by ssb-PositionsInBurst. In an example, a UE may perform SSB measurements and/or perform PDSCH rate-matching based on the semi-static configuration information provided by ssb-PositionsInBurst. A network entity may schedule PDSCHs on resource elements which do not include SSBs while SSB transmissions are indicated by ssb-PositionsInBurst, such as for UEs that can receive a dynamic indication of a SSB transmission pattern. In one implementation, the network entity may schedule PDSCH(s) that overlap with at least a portion of the resource elements of at least one SSB indicated by ssb-PositionsInBurst where the at least one SSB is indicated as not transmitted by the network entity based on the dynamic information of time-domain positions and/or periodicities of transmitted SSBs in an SSB burst; and where the PDSCH(s) is scheduled for UE(s) that can receive a dynamic indication of a SSB transmission pattern. At least some UEs that are not able to receive information regarding a plurality of SSB periodicities can assume one SSB periodicity, such as provided by ssb-PeriodicityServingCell.

According to one or more implementations, when a network entity transmits a plurality of SSBs with multiple different SSB periodicities, the network entity may indicate a shortest periodicity among the multiple different SSB periodicities in the parameter ssb-PeriodicityServingCell for at least some UEs. For an SSB that is transmitted with a longer periodicity than the periodicity provided by ssb-PeriodicityServingCell, some UEs may assume that the SSB is present even though the SSB may not be transmitted by the network entity. In some examples an RSRP measurement value for a corresponding SSB reflects a mismatched UE assumption (e.g., a lower RSRP value due to absence of an SSB), and the UE can eventually select a different SSB which is transmitted with a shorter SSB periodicity or better matched to the UE assumption of SSB transmission pattern. In another additional or alternative example, a network entity may indicate a different periodicity from the multiple different SSB periodicities, such as in the parameter ssb-PeriodicityServingCell for some UEs.

According to one or more implementations, for adaptive SIB1 transmission repetition periodicity, a UE can receive information of one or more SIB1 transmission repetition periodicity values, where each of the one or more SIB1 transmission repetition periodicity values can correspond to a subset of SSBs within an SSB burst. The UE then selects at least one SSB for receiving SIB1, and determines one or more frames and/or slots. The UE, for instance, monitors PDCCH in a Type0-PDCCH common search space (CSS) set (e.g., a search space set for SIB1), based on a SIB1 transmission repetition periodicity value P of the one or more SIB1 transmission repetition periodicity values corresponding to the selected at least one SSB. Further, the UE may receive an indication of a number of slots to monitor PDCCH in the Type0-PDCCH CSS set. The at least one SIB1 transmission repetition periodicity may be selected by a network entity from a set of predefined/configured values, e.g., {20, 40, 80, 160} ms.

According to one or more implementations, at least one SIB1 transmission repetition periodicity value is explicitly indicated via MIB and/or SIB1. In an alternative or additional implementation, at least one SIB1 transmission repetition periodicity value is implicitly indicated via at least one SSB transmission periodicity value indicated in SIB1. For example, a UE determines a SIB1 transmission repetition periodicity value corresponding to a subset of SSBs within an SSB burst based on a periodicity of the subset of SSBs. For instance, a SIB1 transmission repetition periodicity value may be the same as an SSB periodicity of a corresponding SSB and/or based on a predefined or configured mapping between a SIB1 transmission repetition periodicity and a SSB periodicity of a corresponding SSB.

According to one or more implementations, for operation without shared spectrum channel access and for the SS/PBCH block and CORESET multiplexing pattern 1, a UE can monitor PDCCH in a Type0-PDCCH CSS set over one slot or two consecutive slots starting from slot nₒ, e.g., a number of slots to monitor is determined based on an indication. For SS/PBCH block with index i, the UE can determine an index of slot nₒ as nₒ=(O·2^{μ}+└i·M┘) mod Nₛₗₒₜ^{frame} that is in a frame with system frame number (SFN) SFN_{C} satisfying SFN_{c} mod

$$( \frac{P}{10} ) = F ,$$

where P is a SIB1 transmission repetition periodicity value in milliseconds (i.e. a multiple of 10 ms) corresponding to SSB with index i and └(O·2^{μ}+└i·M┘)/Nₛₗₒₜ^{frame}┘ mod

$$( \frac{P}{10} ) = F .$$

For example, M and O are provided by Tables 13-11 and 13-12 of TS 38.213, and μ∈{0, 1, 2, 3} is based on the SCS for PDCCH receptions in the CORESET. An index for a first symbol of the CORESET in slots nₒ and nₒ+1 can be the first symbol index provided by Tables 13-11 and 13-12 of TS 38.213. In at least one example, a UE is not configured to expect that M (e.g., 1/M corresponds to a number of search space sets per slot) is configured with a value equal to or larger than 1, when the SIB1 transmission repetition periodicity value P is configured with a value larger than 20 ms and/or when a cell is in an energy saving mode. For instance, when a cell is in an energy saving mode with a SIB1 transmission repetition periodicity value longer than 20 ms, a network entity can configure two or more search space sets of the Type0-PDCCH CSS for PDCCH that schedules PDSCH carrying SIB1 in a slot, such as to complete SIB1 beam sweeping in a shorter duration.

According to one or more implementations, for operation with shared spectrum channel access and for the SS/PBCH block and CORESET multiplexing pattern 1, a UE can monitor PDCCH in a Type0-PDCCH CSS set over slots that include Type0-PDCCH monitoring occasions. The Type0-PDCCH monitoring occasions, for example, are associated with SS/PBCH blocks that are quasi co-located with a SS/PBCH block that provides a CORESET for Type0-PDCCH CSS set with respect to average gain and quasi co-location ‘typeA’ and ‘typeD’ properties, when applicable. For a candidate SS/PBCH block index ī, where 0≤ī≤L̅ₘₐₓ−1, one slot or two consecutive slots starting from slot n₀ can include the associated Type0-PDCCH monitoring occasions. The UE can determine an index of slot n₀ as n₀=(O·2^{μ}+└ī·M┘) mod Nₛₗₒₜ^{frame,μ} that is in a frame with system frame number (SFN) SFN_{C} satisfying SFN_{C} mod

$$( \frac{P}{10} ) = F ,$$

where P is a SIB1 transmission repetition periodicity value in ms (i.e. a multiple of 10 ms) corresponding to SSB with index ī and └(O·2^{μ}+└ī ·M┘)/Nₛₗₒₜ^{frame,μ}┘ mod

$$( \frac{P}{10} ) = F .$$

For example, M and O are provided by Table 13-11 of TS 38.213, and μ∈{0, 1} based on the SCS for PDCCH receptions in the CORESET. The index for the first symbol of the CORESET in slots n₀ and n₀+1 can be the first symbol index provided by Table 13-11 of TS 38.213. In at least one implementation the UE is not configured to expect to be configured with M=1/2, or with M=2, when N_{SSB}^{QCL}=1.

In at least some implementations, for an SS/PBCH block and CORESET multiplexing patterns 2 and 3, a UE monitors PDCCH in a Type0-PDCCH CSS set over one slot with a SIB1 transmission repetition periodicity value equal to a periodicity of a corresponding SS/PBCH block. For a SS/PBCH block with index i, the UE can determine the PDCCH monitoring slot index n_{c}=N_{SSB,i} (e.g., the same as a slot where the SSB with index i is transmitted) and the PDCCH monitoring frame number SFN_{c}=SFN_{SSB,i}, e.g., the same as a frame where the SSB with index i is transmitted.

According to one or more implementations, adaptive SIB1 and paging transmission and reception are enabled. For instance, a UE can assume that a PDCCH that schedules a PDSCH carrying a SIB1 and the corresponding SIB1 PDSCH (which are quasi-co-located with a SSB with index i) are not transmitted by a network entity, if the UE receives a dynamic indication of time domain positions of transmitted SSBs within an SSB burst indicating that the SSB with index i is not transmitted by the network entity for an associated indication validity duration. Further, the UE may not monitor PDCCH candidates on PDCCH monitoring occasions of a Type0-PDCCH CSS set corresponding to the SSB with index i. The associated indication validity duration may be predefined or configured as part of system information. In an example, a validity interval associated with a dynamic indication may be determined based on a radio frame and/or a slot where the UE receives the dynamic indication, e.g., starting from the radio frame and/or the slot until an end of the configured validity duration.

According to one or more implementations, if a dynamic indication of time-domain positions of transmitted SSBs within an SSB burst is included in DCI format 1_0 with CRC scrambled by SI-RNTI in a current modification period, a UE can apply the dynamic indication. Further, the UE may adjust SIB1 PDCCH monitoring occasions (e.g., reselecting an available SSB and a corresponding SIB1 PDCCH monitoring occasion associated with the available SSB) when re-acquiring system information, from the start of the next modification period. The modification period boundaries can be defined by SFN values for which SFN mod m=0, where m is the number of radio frames comprising the modification period. The modification period can be configured by system information.

In an alternative or additional implementation, if a dynamic indication of time-domain positions of transmitted SSBs within an SSB burst is included in DCI format 1_0 with CRC scrambled by P-RNTI received in a paging occasion in a current defaultPagingCycle (e.g., a default discontinuous reception (DRX) value broadcast in system information), a UE can apply the dynamic indication and may adjust SIB1 PDCCH monitoring occasions (e.g., reselecting an available SSB and a corresponding SIB1 PDCCH monitoring occasion associated with the available SSB) from the start of the next defaultPagingCycle. The defaultPagingCycle boundaries may be defined by SFN values for which (SFN+PF_offset) mod m=0, where m is the number of radio frames comprising the defaultPagingCycle and PF_offset denotes a frame offset of a starting Paging Frame. The defaultPagingCycle is configurable by system information.

In one or more implementations, a UE can assume that a PDCCH of paging DCI and additionally a corresponding PDSCH carrying a paging message (e.g., which are quasi-co-located with a SSB with index i) are not transmitted by a network entity, if the UE receives a dynamic indication of time domain positions of transmitted SSBs within an SSB burst indicating that the SSB with index i is not transmitted by the network entity for an associated indication validity duration. Further, the UE may not monitor PDCCH candidates on PDCCH monitoring occasions of a Type2-PDCCH CSS set corresponding to the SSB with index i. The associated indication validity duration may be predefined or configured as part of system information.

In one or more implementations, if a dynamic indication of time-domain positions of transmitted SSBs within an SSB burst is included in DCI format 1_0 with CRC scrambled by P-RNTI received in a paging occasion in a current defaultPagingCycle (e.g., default DRX value broadcast in system information), a UE can apply the dynamic indication and may adjust paging PDCCH monitoring occasions (e.g., reselecting an available SSB and a corresponding paging PDCCH monitoring occasion associated with the available SSB) from the start of the next defaultPagingCycle.

In one or more implementations, as part of radio resource management (RRM) measurements, when a UE receives information of multiple SSB periodicities for a cell (e.g., each SSB periodicity corresponding to a subset of SSBs within a SSB burst), a time duration required for identifying one or more cells including the cell is determined based on at least the longest SSB periodicity of the multiple SSB periodicities. Further, a measurement period for a frequency layer including the cell can be determined based on the longest SSB periodicity of the multiple SSB periodicities.

According to one or implementations, radio link quality assessment and radio link monitoring (RLM) are supported. For instance, in an example a UE receives a dynamic indication that a given SSB is not available, e.g., via paging DCI, (e.g., DCI format 1_0 with CRC scrambled by P-RNTI), paging early indication DCI, (e.g., DCI format 2_7), MAC CE in SIB1 PDSCH, UE-specific PDSCH), and so forth. In such a scenario the UE may not use the unavailable SSB for RLM and link quality evaluation for an associated indication validity duration, e.g., a validity duration and/or validity interval of a dynamic indication. Further, if a UE receives a dynamic indication that an SSB with index i is not available, the UE may be configured such that the UE may assume that a CSI-RS resource quasi-co-located with the unavailable SSB with index i is not available and may not use the CSI-RS resource for RLM and link quality evaluation for an associated indication validity duration. In one implementation, the UE may be configured to not use (e.g., UE is not expected to use) the CSI-RS resource for tracking (TRS e.g., for time/frequency tracking), or CSI-RS resource for beam management (e.g., CSI-RS resource in a NZP-CSI-RS-ResourceSet configured with higher layer parameter repetition) or the CSI-RS resource for CSI acquisition (e.g., CSI-RS resource in a NZP-CSI-RS-ResourceSet configured without higher layer parameter trs-Info and without the higher layer parameter repetition) for the associated indication validity duration. In another implementation, the UE is not expected to receive (e.g., is not configured to expect to receive) a DCI trigger or MAC-CE activation that indicates a CSI-RS resource quasi-co-located with the unavailable SSB with index i e.g., the SSB is not available for an associated indication validity duration. In some implementations, the quasi-colocation with the SSB may be indicated by the SSB a QCL source RS in the QCL-Info field of a TCI state or indirect quasi-colocation through another RS such as a CSI-RS for tracking (TRS) which is quasi-colocation with the SSB. In at least one implementation the UE may be configured to not monitor PDCCH in a PDCCH search space set with a CORESET, where an active transmission configuration indicator (TCI) state of the CORESET corresponds to the unavailable SSB with index i and/or the CSI-RS resource quasi-co-located with the unavailable SSB with index i. In another implementation, the UE is not expected to receive (e.g., is not configured to expect to receive) a target transmission (e.g., signal or channel) that is associated with a quasi-collocation information or TCI state indicating quasi-collocation relationship between the target transmission (e.g., target RS of DM-RS ports of the target transmission during a transmission occasion) and a source reference signal(s) corresponding to the unavailable SSB with index i or the CSI-RS resource quasi-co-located with the unavailable SSB with index i. In some examples, the UE is not expected to transmit (e.g., the UE is not configured to transmit and/or a network entity does not expect the UE to transmit) a target transmission (e.g., signal or channel) that is associated with a spatial relation information or uplink TCI state indicating a spatial setting between the target transmission (e.g., target RS of DM-RS ports of the target transmission during a transmission occasion) and a source reference signal(s) corresponding to the unavailable SSB with index i or the CSI-RS resource quasi-co-located with the unavailable SSB with index i, where the spatial setting includes transmitting the target transmission with the same spatial domain filter used for reception the source reference RS.

For example, a UE can be provided, for each BWP of a serving cell, a set q̅₀ of periodic CSI-RS resource configuration indexes such as by failureDetectionResourcesToAddModList and a set q̅₁ of periodic CSI-RS resource configuration indexes and/or SS/PBCH block indexes such as by candidateBeamRSList or candidateBeamRSListExt or candidateBeamRSSCellList for radio link quality measurements on the BWP of the serving cell.

In at least one implementation, if the UE is not provided q̅₀ (e.g., by failureDetectionResourcesToAddModList) for a BWP of the serving cell, the UE can determine the set q̅₀ to include periodic CSI-RS resource configuration indexes with same values as the RS indexes in the RS sets indicated by TOI-State for respective CORESETs that the UE uses for monitoring PDCCH. Further, if there are two RS indexes in a TCI state, the set q̅₀ can include RS indexes configured with qcl-Type set to ‘typeD’ for the corresponding TCI states. The UE can be configured to expect: the set q̅₀ to include up to two RS indexes; a single port RS in the set q̅₀; and/or a single-port or two-port CSI-RS with frequency density equal to 1 or 3 REs per RB in the set q̅₁.

According to one or more implementations, a physical layer in the UE assesses the radio link quality according to the set q̅₀ of resource configurations against a threshold Q_{out,LR}. For the set q̅₀, the UE can assess the radio link quality according to available SS/PBCH blocks on the PCell, or the PSCell or periodic CSI-RS resource configurations that are quasi co-located with the demodulation reference signal (DM-RS) of PDCCH receptions monitored by the UE, where the DM-RS of PDCCH receptions are associated (e.g., quasi-co-located) with available SS/PBCH blocks. The UE can apply the Q_{in,LR} threshold to the L1-RSRP measurement obtained from an available SS/PBCH block. The UE can apply the Q_{in,LR} threshold to the L1-RSRP measurement obtained for an available CSI-RS resource after scaling a respective CSI-RS reception power with a value provided by powerControlOffsetSS.

In non-DRX mode operation, the physical layer in the UE can provide an indication to higher layers when the radio link quality for available resources of all corresponding resource configurations in the set q̅₀ that the UE uses to assess the radio link quality is lower than the threshold Q_{out, LR}. The physical layer, for instance, informs the higher layers when the radio link quality is lower than the threshold Q_{out,LR} with a periodicity determined by the maximum between the shortest periodicity among the SS/PBCH blocks on the PCell or the PSCell and/or the periodic CSI-RS configurations in the set q̅₀ that the UE uses to assess the radio link quality and 2 msec. In DRX mode operation, the physical layer provides an indication to higher layers when the radio link quality is lower than the threshold Q_{out,LR} with a specified determined periodicity.

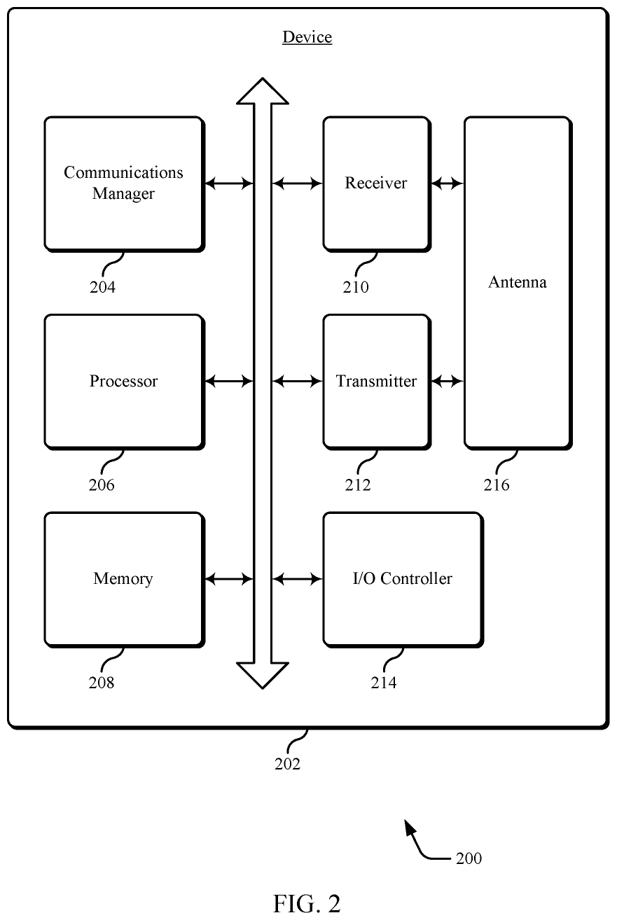

FIG. 2 illustrates an example of a block diagram 200 of a device 202 that supports adaptive communication of system information in accordance with aspects of the present disclosure. The device 202 may be an example of a UE 104 as described herein. The device 202 may support wireless communication and/or network signaling with one or more base stations 102, other UEs 104, or any combination thereof. The device 202 may include components for bi-directional communications including components for transmitting and receiving communications, such as a communications manager 204, a processor 206, a memory 208, a receiver 210, a transmitter 212, and an I/O controller 214. These components may be in electronic communication or otherwise coupled (e.g., operatively, communicatively, functionally, electronically, electrically) via one or more interfaces (e.g., buses).

The communications manager 204, the receiver 210, the transmitter 212, or various combinations thereof or various components thereof may be examples of means for performing various aspects of the present disclosure as described herein. For example, the communications manager 204, the receiver 210, the transmitter 212, or various combinations or components thereof may support a method for performing one or more of the functions described herein.

In some implementations, the communications manager 204, the receiver 210, the transmitter 212, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 206 and the memory 208 coupled with the processor 206 may be configured to perform one or more of the functions described herein (e.g., by executing, by the processor 206, instructions stored in the memory 208).

Additionally or alternatively, in some implementations, the communications manager 204, the receiver 210, the transmitter 212, or various combinations or components thereof may be implemented in code (e.g., as communications management software or firmware) executed by the processor 206. If implemented in code executed by the processor 206, the functions of the communications manager 204, the receiver 210, the transmitter 212, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 204 may be configured to perform various operations (e.g., receiving, monitoring, transmitting) using or otherwise in cooperation with the receiver 210, the transmitter 212, or both. For example, the communications manager 204 may receive information from the receiver 210, send information to the transmitter 212, or be integrated in combination with the receiver 210, the transmitter 212, or both to receive information, transmit information, or perform various other operations as described herein. Although the communications manager 204 is illustrated as a separate component, in some implementations, one or more functions described with reference to the communications manager 204 may be supported by or performed by the processor 206, the memory 208, or any combination thereof. For example, the memory 208 may store code, which may include instructions executable by the processor 206 to cause the device 202 to perform various aspects of the present disclosure as described herein, or the processor 206 and the memory 208 may be otherwise configured to perform or support such operations.

For example, the communications manager 204 may support wireless communication and/or network signaling at a device (e.g., the device 202, a UE) in accordance with examples as disclosed herein. The communications manager 204 and/or other device components may be configured as or otherwise support an apparatus, such as a UE, including a transceiver; and a processor coupled to the transceiver, the processor and the transceiver configured to cause the apparatus to: receive an indication of one or more system information transmission repetition periodicity values corresponding to a respective subset of SSBs within a burst of SSBs; select at least one SSB from the burst of SSBs; receive a system information message via one or more PDCCH monitoring occasions in a search space set for the system information message, the one or more PDCCH monitoring occasions determined based on a system information transmission repetition periodicity value of the one or more system information transmission repetition periodicity values, and the system information transmission repetition periodicity value corresponding to the selected at least one SSB; and implement wireless communication using system information determined from the received system information message.

Additionally, the apparatus (e.g., a UE) includes any one or combination of: where the processor and the transceiver are further configured to cause the apparatus to receive an indication of a plurality of SSB transmission periodicity values, where each subset of SSBs within the burst of SSBs is configured with a SSB transmission periodicity value of the plurality of SSB transmission periodicity values, and where each of the one or more system information transmission repetition periodicity values corresponds to a respective SSB transmission periodicity value of the plurality of SSB transmission periodicity values; where the processor and the transceiver are configured to cause the apparatus to receive the indication of the one or more system information transmission repetition periodicity values as an implicit indication based on the plurality of SSB transmission periodicity values; where the processor and the transceiver are further configured to cause the apparatus to receive an indication of time domain positions of available SSBs within the burst of SSBs, where the indication of time domain positions indicates that a SSB with a first index is not available during a corresponding indication validity interval; where the SSB with the first index is included in a resource set configured for radio link quality assessment, and where the processor and the transceiver are further configured to cause the apparatus to not use the SSB with the first index for radio link quality assessment during the corresponding indication validity interval; where the SSB with the first index is quasi-co-located with a CSI-RS resource included in a resource set configured for radio link quality assessment, and where the processor and the transceiver are further configured to cause the apparatus to not use the CSI-RS resource for radio link quality assessment during the corresponding indication validity interval.

Additionally, the apparatus (e.g., a UE) includes any one or combination of: where the processor and the transceiver are further configured to cause the apparatus to monitor one or more PDCCHs in a PDCCH monitoring occasion of paging DCI during the corresponding indication validity interval, and where the PDCCH monitoring occasion of the paging DCI is not quasi-co-located with the SSB with the first index; where the processor and the transceiver are further configured to cause the apparatus to monitor one or more PDCCHs in a PDCCH monitoring occasion of a common search space set for system information delivery during the corresponding indication validity interval, and where the PDCCH monitoring occasion of the common search space set for system information delivery is not quasi-co-located with the SSB with the first index; where the indication of time domain positions of available SSBs within the burst of SSBs is received via at least one of a MAC-CE or DCI; where the system information message includes at least a part of a minimum system information for a cell of a wireless network.

The communications manager 204 and/or other device components may be configured as or otherwise support a means for wireless communication and/or network signaling at a UE, including receiving an indication of one or more system information transmission repetition periodicity values corresponding to a respective subset of SSBs within a burst of SSBs; selecting at least one SSB from the burst of SSBs; receiving a system information message via one or more PDCCH monitoring occasions in a search space set for the system information message, the one or more PDCCH monitoring occasions determined based on a system information transmission repetition periodicity value of the one or more system information transmission repetition periodicity values, and the system information transmission repetition periodicity value corresponding to the selected at least one SSB; and implementing wireless communication using system information determined from the received system information message.

Additionally, wireless communication at the UE includes any one or combination of: receiving an indication of a plurality of SSB transmission periodicity values, where each subset of SSBs within the burst of SSBs is configured with a SSB transmission periodicity value of the plurality of SSB transmission periodicity values, and where each of the one or more system information transmission repetition periodicity values corresponds to a respective SSB transmission periodicity value of the plurality of SSB transmission periodicity values; receiving the indication of the one or more system information transmission repetition periodicity values as an implicit indication based on the plurality of SSB transmission periodicity values; receiving an indication of time domain positions of available SSBs within the burst of SSBs, where the indication of time domain positions indicates that a SSB with a first index is not available during a corresponding indication validity interval; where the SSB with the first index is included in a resource set configured for radio link quality assessment, and not using the SSB with the first index for radio link quality assessment during the corresponding indication validity interval; where the SSB with the first index is quasi-co-located with a CSI-RS resource included in a resource set configured for radio link quality assessment, and not using the CSI-RS resource for radio link quality assessment during the corresponding indication validity interval; monitoring one or more PDCCHs in a PDCCH monitoring occasion of paging DCI during the corresponding indication validity interval, and where the PDCCH monitoring occasion of the paging DCI is not quasi-co-located with the SSB with the first index; monitoring one or more PDCCHs in a PDCCH monitoring occasion of a common search space set for system information delivery during the corresponding indication validity interval, and where the PDCCH monitoring occasion of the common search space set for system information delivery is not quasi-co-located with the SSB with the first index; where the indication of time domain positions of available SSBs within the burst of SSBs is received via at least one of a MAC-CE or DCI; where the system information message includes at least a part of a minimum system information for a cell of a wireless network.

The processor 206 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 206 may be configured to operate a memory array using a memory controller. In some other implementations, a memory controller may be integrated into the processor 206. The processor 206 may be configured to execute computer-readable instructions stored in a memory (e.g., the memory 208) to cause the device 202 to perform various functions of the present disclosure.

The memory 208 may include random access memory (RAM) and read-only memory (ROM). The memory 208 may store computer-readable, computer-executable code including instructions that, when executed by the processor 206 cause the device 202 to perform various functions described herein. The code may be stored in a non-transitory computer-readable medium such as system memory or another type of memory. In some implementations, the code may not be directly executable by the processor 206 but may cause a computer (e.g., when compiled and executed) to perform functions described herein. In some implementations, the memory 208 may include, among other things, a basic I/O system (BIOS) which may control basic hardware or software operation such as the interaction with peripheral components or devices.

The I/O controller 214 may manage input and output signals for the device 202. The I/O controller 214 may also manage peripherals not integrated into the device 202. In some implementations, the I/O controller 214 may represent a physical connection or port to an external peripheral. In some implementations, the I/O controller 214 may utilize an operating system such as iOS®, ANDROID®, MS-DOS®, MS-WINDOWS®, OS/2®, UNIX®, LINUX®, or another known operating system. In some implementations, the I/O controller 214 may be implemented as part of a processor, such as the processor 206. In some implementations, a user may interact with the device 202 via the I/O controller 214 or via hardware components controlled by the I/O controller 214.

In some implementations, the device 202 may include a single antenna 216. However, in some other implementations, the device 202 may have more than one antenna 216, which may be capable of concurrently transmitting or receiving multiple wireless transmissions. The receiver 210 and the transmitter 212 may communicate bi-directionally, via the one or more antennas 216, wired, or wireless links as described herein. For example, the receiver 210 and the transmitter 212 may represent a wireless transceiver and may communicate bi-directionally with another wireless transceiver. The transceiver may also include a modem to modulate the packets, to provide the modulated packets to one or more antennas 216 for transmission, and to demodulate packets received from the one or more antennas 216.

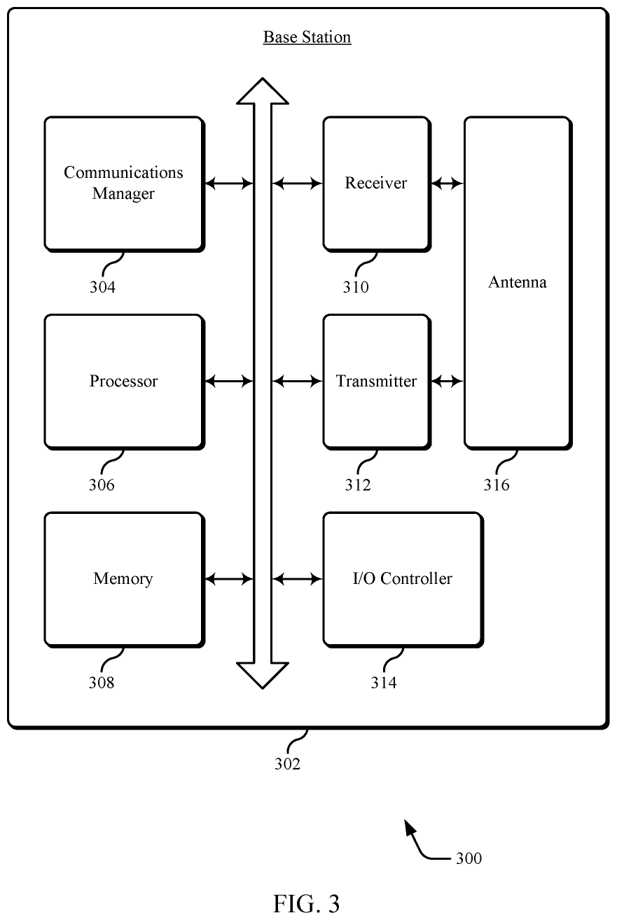

FIG. 3 illustrates an example of a block diagram 300 of a device 302 that supports adaptive communication of system information in accordance with aspects of the present disclosure. The device 302 may be an example of a base station 102, such as a gNB as described herein. The device 302 may support wireless communication and/or network signaling with one or more base stations 102, other UEs 104, or any combination thereof. The device 302 may include components for bi-directional communications including components for transmitting and receiving communications, such as a communications manager 304, a processor 306, a memory 308, a receiver 310, a transmitter 312, and an I/O controller 314. These components may be in electronic communication or otherwise coupled (e.g., operatively, communicatively, functionally, electronically, electrically) via one or more interfaces (e.g., buses).

The communications manager 304, the receiver 310, the transmitter 312, or various combinations thereof or various components thereof may be examples of means for performing various aspects of the present disclosure as described herein. For example, the communications manager 304, the receiver 310, the transmitter 312, or various combinations or components thereof may support a method for performing one or more of the functions described herein.

In some implementations, the communications manager 304, the receiver 310, the transmitter 312, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 306 and the memory 308 coupled with the processor 306 may be configured to perform one or more of the functions described herein (e.g., by executing, by the processor 306, instructions stored in the memory 308).

Additionally or alternatively, in some implementations, the communications manager 304, the receiver 310, the transmitter 312, or various combinations or components thereof may be implemented in code (e.g., as communications management software or firmware) executed by the processor 306. If implemented in code executed by the processor 306, the functions of the communications manager 304, the receiver 310, the transmitter 312, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 304 may be configured to perform various operations (e.g., receiving, monitoring, transmitting) using or otherwise in cooperation with the receiver 310, the transmitter 312, or both. For example, the communications manager 304 may receive information from the receiver 310, send information to the transmitter 312, or be integrated in combination with the receiver 310, the transmitter 312, or both to receive information, transmit information, or perform various other operations as described herein. Although the communications manager 304 is illustrated as a separate component, in some implementations, one or more functions described with reference to the communications manager 304 may be supported by or performed by the processor 306, the memory 308, or any combination thereof. For example, the memory 308 may store code, which may include instructions executable by the processor 306 to cause the device 302 to perform various aspects of the present disclosure as described herein, or the processor 306 and the memory 308 may be otherwise configured to perform or support such operations.

For example, the communications manager 304 may support wireless communication and/or network signaling at a device (e.g., the device 302, base station) in accordance with examples as disclosed herein. The communications manager 304 and/or other device components may be configured as or otherwise support an apparatus, such as a base station, including a transceiver; and a processor coupled to the transceiver, the processor and the transceiver configured to cause the apparatus to: transmit an indication of one or more system information transmission repetition periodicity values corresponding to a respective subset of SSBs within a burst of SSBs; and perform a plurality of transmissions of a system information message, where each transmission of the system information message is quasi-co-located with a SSB within the burst of SSBs and is repeated with a system information transmission repetition periodicity value corresponding to the SSB.

Additionally, the apparatus (e.g., a base station) includes any one or combination of: where the processor and the transceiver are further configured to cause the apparatus to estimate a spatial distribution of user equipment within a wireless service area and generate the one or more system information transmission repetition periodicity values based on the spatial distribution of the user equipment; where to generate the one or more system information transmission repetition periodicity values based on the spatial distribution of the user equipment includes to decrease a current system information transmission repetition periodicity value corresponding to a SSB within the burst of SSBs.

Additionally, the apparatus (e.g., a base station) includes any one or combination of: where the processor and the transceiver are further configured to: transmit an indication of a plurality of SSB transmission periodicity values, where each subset of SSBs within the burst of SSBs is configured with a SSB transmission periodicity value of the plurality of SSB transmission periodicity values, and where each of the one or more system information transmission repetition periodicity values corresponds to a respective SSB transmission periodicity value of the plurality of SSB transmission periodicity values; and transmit the burst of SSBs based on the plurality of SSB transmission periodicity values; where the processor and the transceiver are further configured to cause the apparatus to: generate an indication of time domain positions of available SSBs within the burst of SSBs, where the indication of time domain positions indicates that a SSB with a first index is not available during a corresponding indication validity interval; and transmit the indication of time domain positions; where the processor and the transceiver are further configured to cause the apparatus to generate the indication of time domain positions as one or more of a MAC-CE or DCI; where the processor and the transceiver are further configured to cause the apparatus to perform a set of transmissions of a system information message and a set of transmissions of a paging message corresponding to the available SSBs within the burst of SSBs; where the processor and the transceiver are further configured to cause the apparatus to: generate a MIB that identifies the one or more system information transmission repetition periodicity values; and transmit the MIB.

The communications manager 304 and/or other device components may be configured as or otherwise support a means for wireless communication and/or network signaling at a base station, including transmitting an indication of one or more system information transmission repetition periodicity values corresponding to a respective subset of SSBs within a burst of SSBs; and performing a plurality of transmissions of a system information message, where each transmission of the system information message is quasi-co-located with a SSB within the burst of SSBs and is repeated with a system information transmission repetition periodicity value corresponding to the SSB.

Additionally, wireless communication at the base station includes any one or combination of: estimating a spatial distribution of user equipment within a wireless service area and generating the one or more system information transmission repetition periodicity values based on the spatial distribution of the user equipment; where generating the one or more system information transmission repetition periodicity values based on the spatial distribution of the user equipment includes to decrease a current system information transmission repetition periodicity value corresponding to a SSB within the burst of SSBs; transmitting an indication of a plurality of SSB transmission periodicity values, where each subset of SSBs within the burst of SSBs is configured with a SSB transmission periodicity value of the plurality of SSB transmission periodicity values, and where each of the one or more system information transmission repetition periodicity values corresponds to a respective SSB transmission periodicity value of the plurality of SSB transmission periodicity values; and transmitting the burst of SSBs based on the plurality of SSB transmission periodicity values; generating an indication of time domain positions of available SSBs within the burst of SSBs, where the indication of time domain positions indicates that a SSB with a first index is not available during a corresponding indication validity interval; and transmitting the indication of time domain positions; generating the indication of time domain positions as one or more of a MAC-CE or DCI; performing a set of transmissions of a system information message and a set of transmissions of a paging message corresponding to the available SSBs within the burst of SSBs; generating a MIB that identifies the one or more system information transmission repetition periodicity values; and transmitting the MIB.

The processor 306 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 306 may be configured to operate a memory array using a memory controller. In some other implementations, a memory controller may be integrated into the processor 306. The processor 306 may be configured to execute computer-readable instructions stored in a memory (e.g., the memory 308) to cause the device 302 to perform various functions of the present disclosure.

The memory 308 may include random access memory (RAM) and read-only memory (ROM). The memory 308 may store computer-readable, computer-executable code including instructions that, when executed by the processor 306 cause the device 302 to perform various functions described herein. The code may be stored in a non-transitory computer-readable medium such as system memory or another type of memory. In some implementations, the code may not be directly executable by the processor 306 but may cause a computer (e.g., when compiled and executed) to perform functions described herein. In some implementations, the memory 308 may include, among other things, a basic I/O system (BIOS) which may control basic hardware or software operation such as the interaction with peripheral components or devices.

The I/O controller 314 may manage input and output signals for the device 302. The I/O controller 314 may also manage peripherals not integrated into the device 302. In some implementations, the I/O controller 314 may represent a physical connection or port to an external peripheral. In some implementations, the I/O controller 314 may utilize an operating system such as iOS®, ANDROID®, MS-DOS®, MS-WINDOWS®, OS/2®, UNIX®, LINUX®, or another known operating system. In some implementations, the I/O controller 314 may be implemented as part of a processor, such as the processor 306. In some implementations, a user may interact with the device 302 via the I/O controller 314 or via hardware components controlled by the I/O controller 314.

In some implementations, the device 302 may include a single antenna 316. However, in some other implementations, the device 302 may have more than one antenna 316, which may be capable of concurrently transmitting or receiving multiple wireless transmissions. The receiver 310 and the transmitter 312 may communicate bi-directionally, via the one or more antennas 316, wired, or wireless links as described herein. For example, the receiver 310 and the transmitter 312 may represent a wireless transceiver and may communicate bi-directionally with another wireless transceiver. The transceiver may also include a modem to modulate the packets, to provide the modulated packets to one or more antennas 316 for transmission, and to demodulate packets received from the one or more antennas 316.

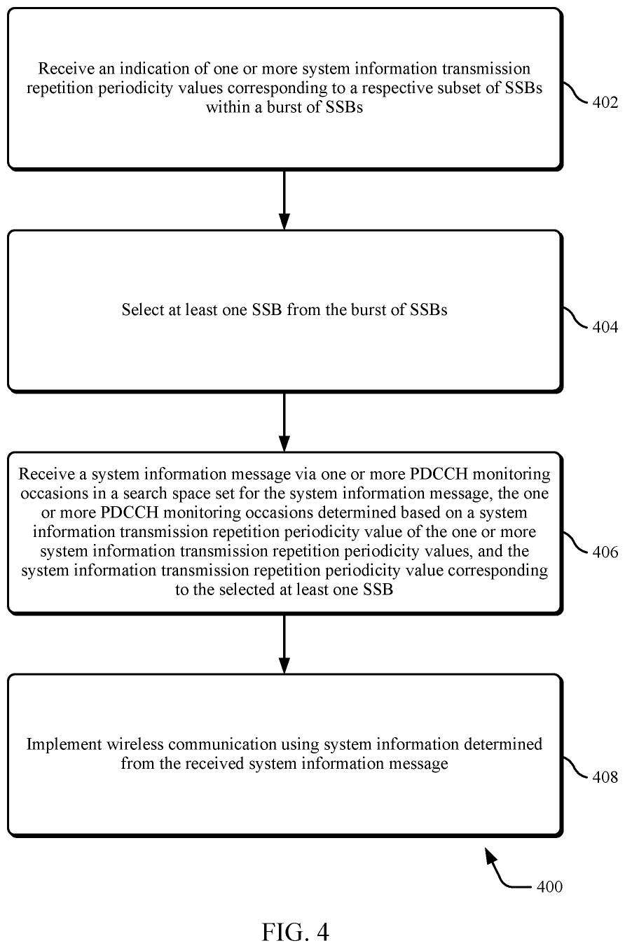

FIG. 4 illustrates a flowchart of a method 400 that supports adaptive communication of system information in accordance with aspects of the present disclosure. The operations of the method 400 may be implemented by a device or its components as described herein. For example, the operations of the method 400 may be performed by a device, such as UE 104 as described with reference to FIGS. 1 through 3. In some implementations, the device may execute a set of instructions to control the function elements of the device to perform the described functions. Additionally, or alternatively, the device may perform aspects of the described functions using special-purpose hardware.

At 402, the method may include receiving an indication of one or more system information transmission repetition periodicity values corresponding to a respective subset of SSBs within a burst of SSBs. The operations of 402 may be performed in accordance with examples as described herein. In some implementations, aspects of the operations of 402 may be performed by a device as described with reference to FIG. 1.

At 404, the method may include selecting at least one SSB from the burst of SSBs. The operations of 404 may be performed in accordance with examples as described herein. In some implementations, aspects of the operations of 404 may be performed by a device as described with reference to FIG. 1.

At 406, the method may include receiving a system information message via one or more PDCCH monitoring occasions in a search space set for the system information message, the one or more PDCCH monitoring occasions determined based on a system information transmission repetition periodicity value of the one or more system information transmission repetition periodicity values, and the system information transmission repetition periodicity value corresponding to the selected at least one SSB. The operations of 406 may be performed in accordance with examples as described herein. In some implementations, aspects of the operations of 406 may be performed by a device as described with reference to FIG. 1.

At 408, the method may include implementing wireless communication using system information determined from the received system information message. The operations of 408 may be performed in accordance with examples as described herein. In some implementations, aspects of the operations of 408 may be performed by a device as described with reference to FIG. 1.

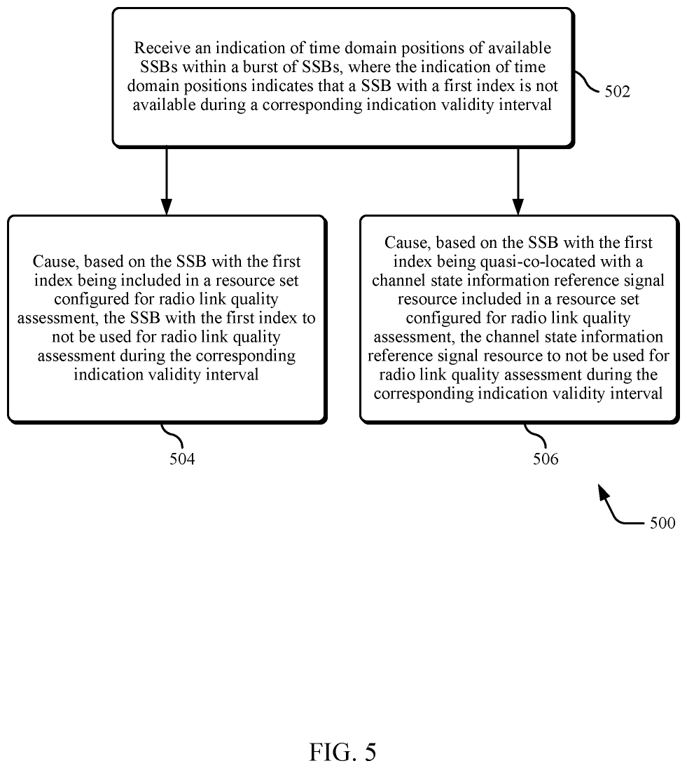

FIG. 5 illustrates a flowchart of a method 500 that supports adaptive communication of system information in accordance with aspects of the present disclosure. The operations of the method 500 may be implemented by a device or its components as described herein. For example, the operations of the method 500 may be performed by a device, such as UE 104 as described with reference to FIGS. 1 through 3. In some implementations, the device may execute a set of instructions to control the function elements of the device to perform the described functions. Additionally, or alternatively, the device may perform aspects of the described functions using special-purpose hardware.

At 502, the method may include receiving an indication of time domain positions of available SSBs within a burst of SSBs, where the indication of time domain positions indicates that a SSB with a first index is not available during a corresponding indication validity interval. The operations of 502 may be performed in accordance with examples as described herein. In some implementations, aspects of the operations of 502 may be performed by a device as described with reference to FIG. 1.

At 504, the method may include causing, based on the SSB with the first index being included in a resource set configured for radio link quality assessment, the SSB with the first index to not be used for radio link quality assessment during the corresponding indication validity interval. The operations of 504 may be performed in accordance with examples as described herein. In some implementations, aspects of the operations of 504 may be performed by a device as described with reference to FIG. 1.

At 506, the method may include causing, based on the SSB with the first index being quasi-co-located with a channel state information reference signal resource included in a resource set configured for radio link quality assessment, the channel state information reference signal resource to not be used for radio link quality assessment during the corresponding indication validity interval. The operations of 506 may be performed in accordance with examples as described herein. In some implementations, aspects of the operations of 506 may be performed by a device as described with reference to FIG. 1.

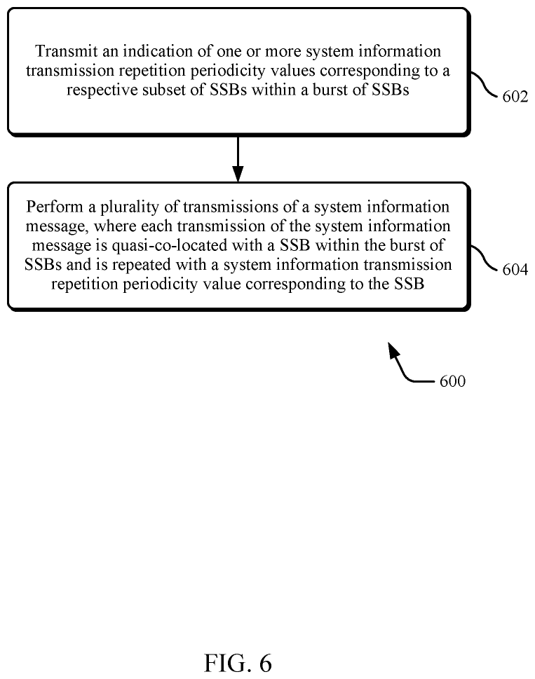

FIG. 6 illustrates a flowchart of a method 600 that supports adaptive communication of system information in accordance with aspects of the present disclosure. The operations of the method 600 may be implemented by a device or its components as described herein. For example, the operations of the method 600 may be performed by a base station 102, such as a gNB as described with reference to FIGS. 1 through 3. In some implementations, the device may execute a set of instructions to control the function elements of the device to perform the described functions. Additionally, or alternatively, the device may perform aspects of the described functions using special-purpose hardware.

At 602, the method may include transmitting an indication of one or more system information transmission repetition periodicity values corresponding to a respective subset of SSBs within a burst of SSBs. The operations of 602 may be performed in accordance with examples as described herein. In some implementations, aspects of the operations of 602 may be performed by a device as described with reference to FIG. 1.

At 604, the method may include performing a plurality of transmissions of a system information message, where each transmission of the system information message is quasi-co-located with a SSB within the burst of SSBs and is repeated with a system information transmission repetition periodicity value corresponding to the SSB. The operations of 604 may be performed in accordance with examples as described herein. In some implementations, aspects of the operations of 604 may be performed by a device as described with reference to FIG. 1.

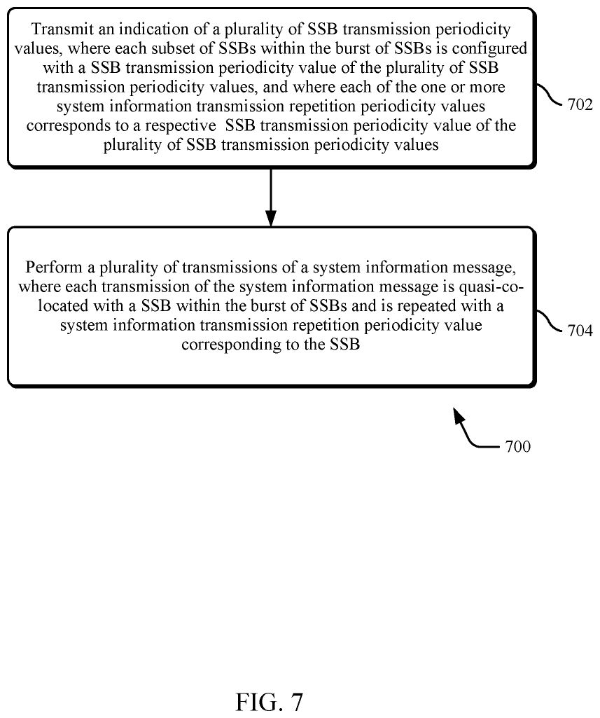

FIG. 7 illustrates a flowchart of a method 700 that supports adaptive communication of system information in accordance with aspects of the present disclosure. The operations of the method 700 may be implemented by a device or its components as described herein. For example, the operations of the method 700 may be performed by a base station 102, such as a gNB as described with reference to FIGS. 1 through 3. In some implementations, the device may execute a set of instructions to control the function elements of the device to perform the described functions. Additionally, or alternatively, the device may perform aspects of the described functions using special-purpose hardware.

At 702, the method may include transmitting an indication of a plurality of SSB transmission periodicity values, where each subset of SSBs within a burst of SSBs is configured with a SSB transmission periodicity value of the plurality of SSB transmission periodicity values, and where each of the one or more system information transmission repetition periodicity values corresponds to a respective SSB transmission periodicity value of the plurality of SSB transmission periodicity values. The operations of 702 may be performed in accordance with examples as described herein. In some implementations, aspects of the operations of 702 may be performed by a device as described with reference to FIG. 1.

At 704, the method may include transmitting the burst of SSBs based on the plurality of SSB transmission periodicity values. The operations of 704 may be performed in accordance with examples as described herein. In some implementations, aspects of the operations of 704 may be performed by a device as described with reference to FIG. 1.

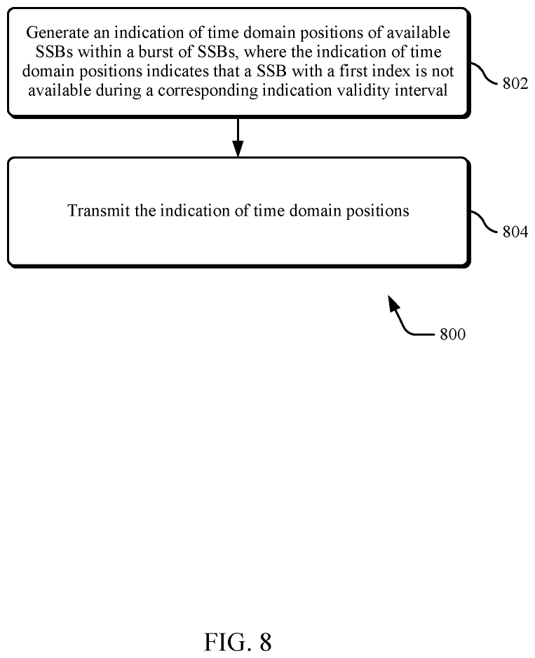

FIG. 8 illustrates a flowchart of a method 800 that supports adaptive communication of system information in accordance with aspects of the present disclosure. The operations of the method 800 may be implemented by a device or its components as described herein. For example, the operations of the method 800 may be performed by a base station 102, such as a gNB as described with reference to FIGS. 1 through 3. In some implementations, the device may execute a set of instructions to control the function elements of the device to perform the described functions. Additionally, or alternatively, the device may perform aspects of the described functions using special-purpose hardware.

At 802, the method may include generating an indication of time domain positions of available SSBs within a burst of SSBs, where the indication of time domain positions indicates that a SSB with a first index is not available during a corresponding indication validity interval. The operations of 802 may be performed in accordance with examples as described herein. In some implementations, aspects of the operations of 802 may be performed by a device as described with reference to FIG. 1.

At 804, the method may include transmitting the indication of time domain positions. The operations of 804 may be performed in accordance with examples as described herein. In some implementations, aspects of the operations of 804 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive an indication of one or more system information transmission repetition periodicity values corresponding to a respective subset of synchronization signal blocks (SSBs) within a burst of SSBs;
select at least one SSB from the burst of SSBs;
receive a system information message via one or more physical downlink control channel (PDCCH) monitoring occasions in a search space set for the system information message, the one or more PDCCH monitoring occasions determined based on a system information transmission repetition periodicity value of the one or more system information transmission repetition periodicity values, and the system information transmission repetition periodicity value corresponding to the selected at least one SSB; and
implement wireless communication using system information determined from the received system information message.

2. The UE of claim 1, wherein the at least one processor is further configured to cause the UE to receive an indication of a plurality of SSB transmission periodicity values, wherein each subset of SSBs within the burst of SSBs is configured with a SSB transmission periodicity value of the plurality of SSB transmission periodicity values, and wherein each of the one or more system information transmission repetition periodicity values corresponds to a respective SSB transmission periodicity value of the plurality of SSB transmission periodicity values.

3. The UE of claim 2, wherein the at least one processor is configured to cause the UE to receive the indication of the one or more system information transmission repetition periodicity values as an implicit indication based on the plurality of SSB transmission periodicity values.

4. The UE of claim 1, wherein the at least one processor is further configured to cause the UE to receive an indication of time domain positions of available SSBs within the burst of SSBs, wherein the indication of time domain positions indicates that a SSB with a first index is not available during a corresponding indication validity interval.

5. The UE of claim 4, wherein the SSB with the first index is included in a resource set configured for radio link quality assessment, and wherein the at least one processor is further configured to cause the UE to not use the SSB with the first index for radio link quality assessment during the corresponding indication validity interval.

6. The UE of claim 4, wherein the SSB with the first index is quasi-co-located with a channel state information reference signal resource included in a resource set configured for radio link quality assessment, and wherein the at least one processor is further configured to cause the UE to not use the channel state information reference signal resource for radio link quality assessment during the corresponding indication validity interval.

7. The UE of claim 4, wherein the at least one processor is further configured to cause the UE to monitor one or more PDCCHs in a PDCCH monitoring occasion of paging downlink control information during the corresponding indication validity interval, and wherein the PDCCH monitoring occasion of the paging downlink control information is not quasi-co-located with the SSB with the first index.

8. The UE of claim 4, wherein the at least one processor is further configured to cause the UE to monitor one or more PDCCHs in a PDCCH monitoring occasion of a common search space set for system information delivery during the corresponding indication validity interval, and wherein the PDCCH monitoring occasion of the common search space set for system information delivery is not quasi-co-located with the SSB with the first index.

9. The UE of claim 4, wherein the indication of time domain positions of available SSBs within the burst of SSBs is received via at least one of a medium access control control element or downlink control information.

10. The UE of claim 1, wherein the system information message comprises at least a part of a minimum system information for a cell of a wireless network.

11. A base station for wireless communication, comprising:
at least one memory; and
at least one processor coupled with the at least one memory and configured to cause the base station to:
transmit an indication of one or more system information transmission repetition periodicity values corresponding to a respective subset of synchronization signal blocks (SSBs) within a burst of SSBs; and
perform a plurality of transmissions of a system information message, wherein each transmission of the system information message is quasi-co-located with an SSB within the burst of SSBs and is repeated with a system information transmission repetition periodicity value corresponding to the SSB.

12. The base station of claim 11, wherein the at least one processor is further configured to cause the base station to estimate a spatial distribution of user equipment within a wireless service area and generate the one or more system information transmission repetition periodicity values based on the spatial distribution of the user equipment.

13. The base station of claim 12, wherein to generate the one or more system information transmission repetition periodicity values based on the spatial distribution of the user equipment comprises to decrease a current system information transmission repetition periodicity value corresponding to a SSB within the burst of SSBs.

14. The base station of claim 11, wherein the at least one processor is further configured to cause the base station to:
transmit an indication of a plurality of SSB transmission periodicity values, wherein each subset of SSBs within the burst of SSBs is configured with a SSB transmission periodicity value of the plurality of SSB transmission periodicity values, and wherein each of the one or more system information transmission repetition periodicity values corresponds to a respective SSB transmission periodicity value of the plurality of SSB transmission periodicity values; and
transmit the burst of SSBs based on the plurality of SSB transmission periodicity values.

15. The base station of claim 11, wherein the at least one processor is further configured to cause the base station to:
generate an indication of time domain positions of available SSBs within the burst of SSBs, wherein the indication of time domain positions indicates that a SSB 2 with a first index is not available during a corresponding indication validity interval; and
transmit the indication of time domain positions.

16. The base station of claim 15, wherein the at least one processor is further configured to cause the base station to generate the indication of time domain positions as one or more of a medium access control control element or downlink control information.

17. The base station of claim 15, wherein the at least one processor is further configured to cause the base station to perform a set of transmissions of a system information message and a set of transmissions of a paging message corresponding to the available SSBs within the burst of SSBs.

18. The base station of claim 11, wherein the at least one processor is further configured to cause the base station to:
generate a master information block that identifies the one or more system information transmission repetition periodicity values; and
transmit the master information block.

19. A method performed by a user equipment (UE), the method comprising:
receiving an indication of one or more system information transmission repetition periodicity values corresponding to a respective subset of synchronization signal blocks (SSBs) within a burst of SSBs;
selecting at least one SSB from the burst of SSBs;
receiving a system information message via one or more physical downlink control channel (PDCCH) monitoring occasions in a search space set for the system information message, the one or more PDCCH monitoring occasions determined based on a system information transmission repetition periodicity value of the one or more system information transmission repetition periodicity values, and the system information transmission repetition periodicity value corresponding to the selected at least one SSB; and
implementing wireless communication using system information determined from the received system information message.

20. (canceled)

21. A processor for wireless communication, comprising:
at least one controller coupled with at least one memory and configured to cause the processor to:
receive an indication of one or more system information transmission repetition periodicity values corresponding to a respective subset of synchronization signal blocks (SSBs) within a burst of SSBs;
select at least one SSB from the burst of SSBs;
receive a system information message via one or more physical downlink control channel (PDCCH) monitoring occasions in a search space set for the system information message, the one or more PDCCH monitoring occasions determined based on a system information transmission repetition periodicity value of the one or more system information transmission repetition periodicity values, and the system information transmission repetition periodicity value corresponding to the selected at least one SSB; and
implement wireless communication using system information determined from the received system information message.
